(19) United States
(12) Patent Application Publication
(10) Pub. No.: US 2006/0228619 A1
(43) Pub. Date: Oct. 12, 2006

(54) Electrochemical cell structure

(75) Inventors: John Henry Bowen, Greenfield Center, NY (US); Richard Scott Bourgeois, Albany, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company

(21) Appl. No.: 11/103,971

(22) Filed: Apr. 12, 2005

(51) Int. Cl. H01M 8/02; C25B 9/00

(52) U.S. Cl. 429/39; 204/267; 204/269

(57) ABSTRACT

An electrochemical cell structure comprises an anode, a cathode spaced apart from the anode and an electrolyte in ionic communication with each of the cathode and the anode. A single-piece nonconductive frame supports each of the anode, the cathode and the electrolyte and defines a flowpath for working fluids and for byproducts or ionic exchange.

### STATEMENT REGARDING FEDERALLY SPONSORED RESEARCH & DEVELOPMENT

This invention was conceived or first reduced to practice under a project funded by the Department of Energy under contract DE-FC36-04GO14223. The United States Government has certain rights related to this invention.

### BACKGROUND

The invention relates generally to electrochemical cell structures and more specifically to electrochemical cell structures having single-piece nonconductive frames that support the anode, the cathode and the electrolyte and define flowpaths for working fluids and for byproducts of ionic exchange.

Electrochemical cells are energy conversion devices that are usually classified as either electrolysis cells or fuel cells. Electrolysis cells can function as hydrogen generators by electrolytically decomposing water to produce hydrogen and oxygen gases. Fuel cells electrochemically react a hydrogen gas with an oxidant across an exchange membrane or electrolyte to generate electricity and produce water.

Alkaline electrolysis systems have been commercially available for several decades. Direct current voltage of about 1.7V to about 2.2V is applied to two electrodes that are positioned within a liquid electrolyte. At the positive electrode, oxygen is produced and at the negative electrode, hydrogen forms. An ion-permeable diaphragm keeps the gases separated.

For electrochemical systems, especially alkaline electrolysis systems, to become economically feasible the manufacturing costs associated with these systems must markedly improve. Current systems require numerous process steps during assembly, with each step adding cost to the overall system. Additionally, conventional systems currently have many individual component parts including multiple electrodes, diaphragms, gaskets, bolts and other miscellaneous parts that add to the complexity of the system assembly and drive the manufacturing costs up.

Accordingly, there is a need for an improved electrochemical cell that promotes an overall reduction in the number of component parts and simplifies the associated manufacturing and fabrication process.

### BRIEF DESCRIPTION

An electrochemical cell structure comprises an anode, a cathode spaced apart from the anode and an electrolyte in ionic communication with each of the cathode and the anode. A single-piece nonconductive frame supports each of the anode, the cathode and the electrolyte and defines flowpaths for working fluids and for byproducts of ionic exchange.

### DRAWINGS

These and other features, aspects, and advantages of the present invention will become better understood when the following detailed description is read with reference to the accompanying drawings in which like characters represent like parts throughout the drawings, wherein:

FIG. 1 is a side cross-sectional view of one embodiment of the instant invention.

FIG. 2 is a schematic representation of an alkaline electrolysis system.

FIG. 3 is schematic representation of an exemplary alkaline electrolysis stack arrangement.

FIG. 4 is an exploded view of one embodiment of the instant invention.

FIG. 5 is a side view of an electrode insert in accordance with one embodiment of the instant invention.

FIG. 6 is a perspective view of end caps in accordance with one embodiment of the instant invention.

FIG. 7 is a top view of electrochemical cell structure in accordance with one embodiment of the instant invention.

FIG. 8 is a side view of the electrochemical cell structure shown in FIG. 7.

FIG. 9 is a flow chart representation of one method of fabrication of the instant invention.

FIG. 10 is a flow chart representation of another method of fabrication of the instant invention.

FIG. 11 is a schematic representation of an alkaline electrolysis system in accordance with the instant invention.

### DETAILED DESCRIPTION

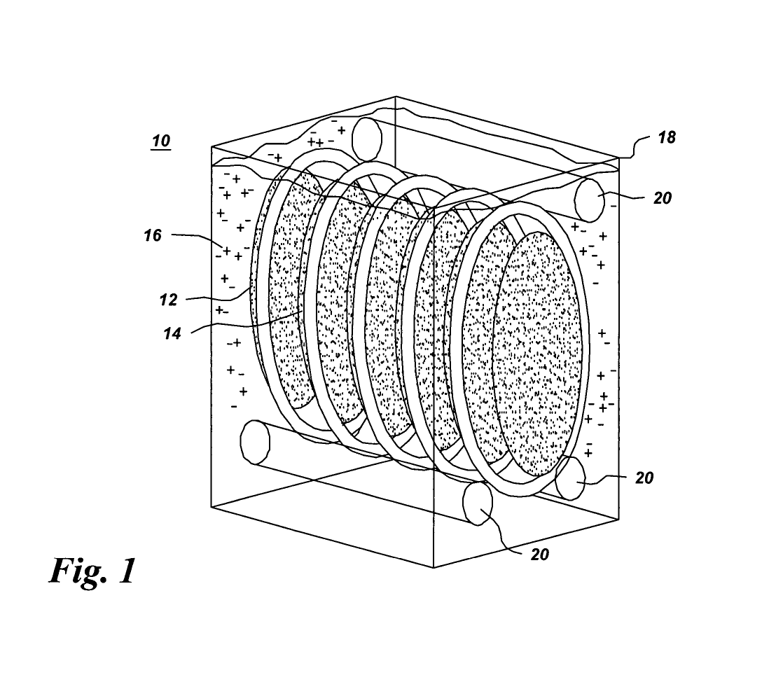

An electrochemical cell structure 10 comprising an anode 12, a cathode 14 spaced apart from the anode 12, an electrolyte 16 in ionic communication with each of the anode 12 and the cathode 14, and a single-piece nonconductive frame 18, is shown in FIG. 1. The single-piece nonconductive frame 18 supports the anode 12, the cathode 14 and the electrolyte 16 and defines a plurality of flowpaths 20 for working fluids (not shown) or byproducts of ionic exchange (not shown). As shown in FIG. 1, because the elements are encased in the single-piece nonconductive frame 18 and the flowpaths 20 are defined by the same, the construction is efficient and effective (no gaskets or seals are required) and the fabrication process is simplified.

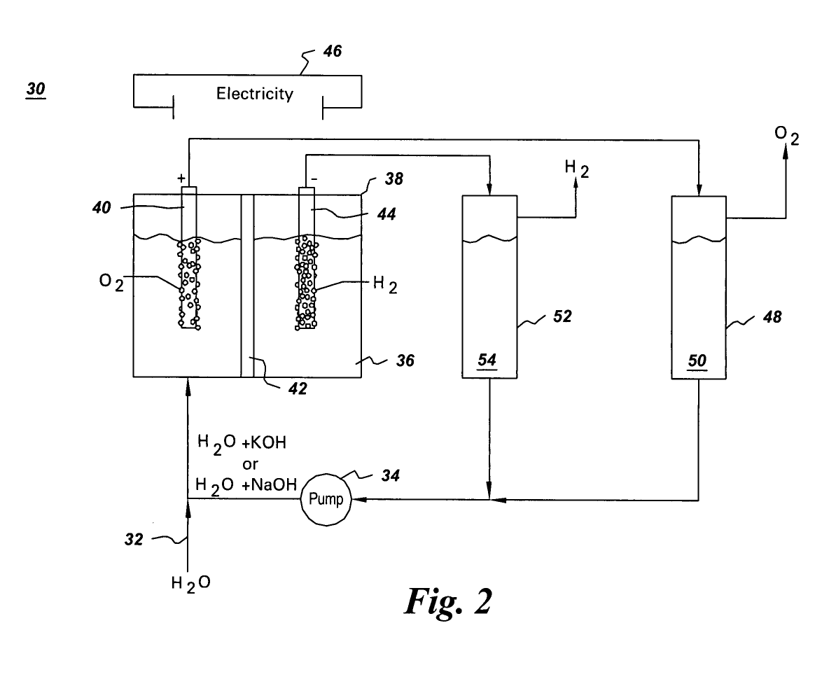

One type of electrochemical cell structure is utilized within an alkaline electrolysis system 30, as schematically shown in FIG. 2. Water (H₂O) is supplied into the system 30 via inlet 32 and is circulated by pump 34. The water is combined with a base, typically Potassium Hydroxide (KOH) or Sodium Hydroxide (NaOH), to form a liquid alkaline electrolyte 36, which electrolyte 36 is circulated by pump 34 to electrolyzer 38. Electrolyzer 38 includes an anode 40 (+ electrode), a diaphragm 42 and a cathode 44 (− electrode). Direct current voltage 46 is applied to the anode 40 and the cathode 44 in the presence of the electrolyte 36. The direct current voltage, typically a voltage in the range between about 1.7V to about 2.2V, splits the water into its constituents of hydrogen (H₂) at the cathode 44 and oxygen (O₂) at the anode 40. Diaphragm 42 keeps the H₂ and O₂ gases separated. The O₂ gas in mixture with electrolyte 36 is transported to an oxygen separator 48. After separation from the electrolyte 36, the O₂ gas is stored, vented, or otherwise utilized and a portion of the electrolyte 50 is recirculated by pump 34 into system 30. The H₂ gas in mixture with liquid electrolyte 36 is transported to a hydrogen separator 52. After separation from the electrolyte 36, the H₂ gas is captured and stored, burned, electrochemically reacted or otherwise utilized and a portion of the electrolyte 54 is recirculated by pump 34 into system 30.

As discussed above, in order for electrochemical systems, especially alkaline electrolysis systems, to become economically feasible the manufacturing costs associated with these systems must markedly improve. Current systems require numerous process steps during assembly, with each step adding cost to the overall system. Additionally, conventional systems currently have many individual component parts including multiple electrodes, diaphragms, gaskets, bolts and other miscellaneous parts that add to the complexity of the system assembly and drive the manufacturing costs up.

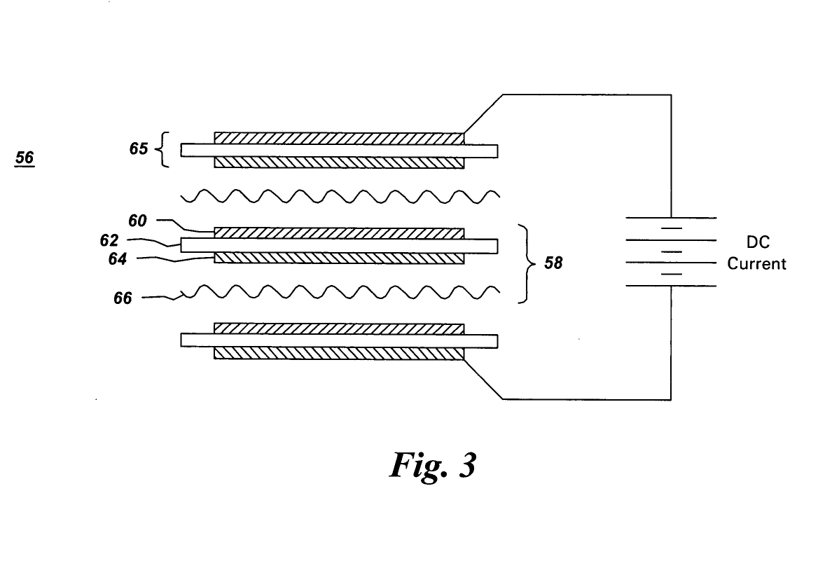

One particularly difficult and expensive fabrication area is the stack assembly within these electrochemical systems. Taking an alkaline electrolysis stack as an exemplary stack arrangement, the general configuration and fabrication difficulties can be discussed in reference to FIG. 3. As shown in FIG. 3, a typical stack assembly 56 includes a plurality of repeat units 58. Each repeat unit 58 includes an anode 60, a bipolar plate 62, a cathode 64 and a diaphragm 66. Any large-scale implementation of an alkaline electrolysis stack may include as many as a hundred or more repeat units 58. Each repeat unit 58 requires electrical coupling between the anode 60, the bipolar plate 62 and the cathode 64, referred to as the electrode assembly 65. Each electrode assembly 65 must be separated by a diaphragm 66, primarily to keep the hydrogen and oxygen gases from mixing between adjacent electrode assemblies 65. All of the repeat units 58 within a stack must be positioned within some type of housing, and surrounded by nonconductive gasketing, sealing technologies, and piping or manifolds to distribute the electrolyte and to capture the hydrogen and oxygen gases. Hundreds or possibly thousands of connections and bolts or other fasteners are used to assemble this type of stack, further impacting the fabrication costs.

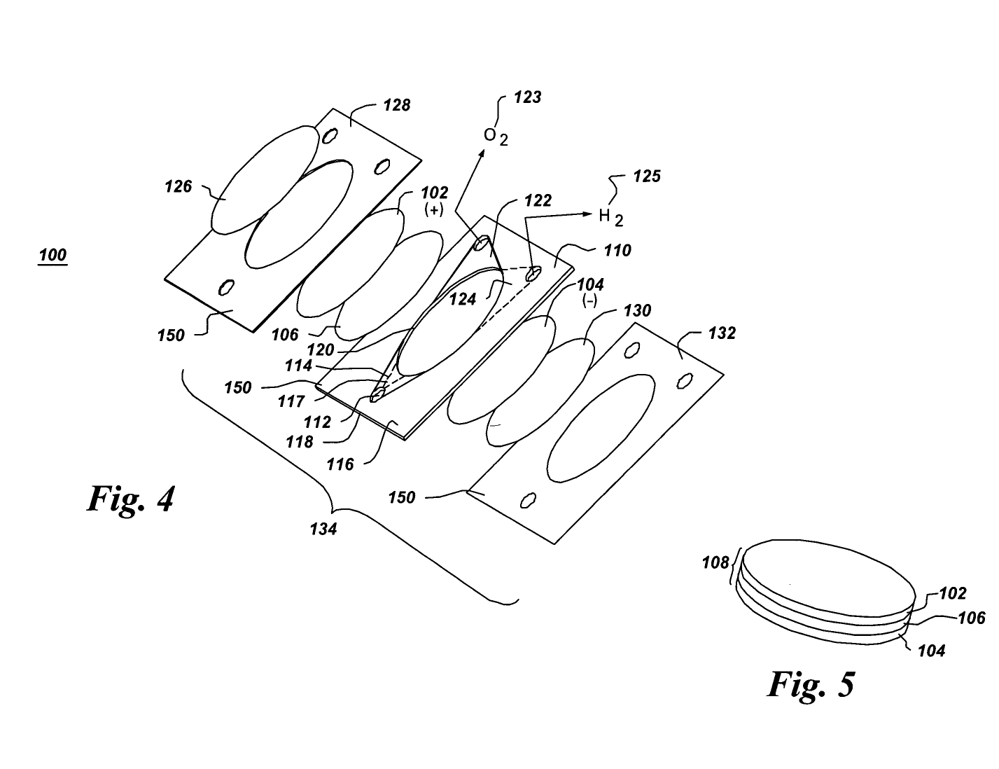

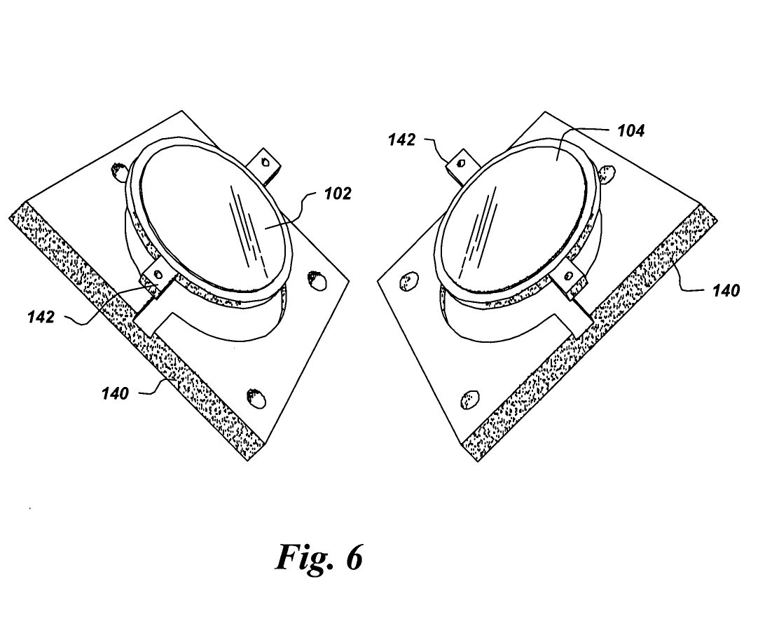

In accordance with one embodiment of the instant invention, an electrochemical cell structure 100 is shown in FIGS. 4-8. Electrochemical cell structure 100 is shown in an exploded view to better demonstrate the constituent parts in FIG. 4. Electrochemical cell structure 100 comprises an anode 102 and a cathode 104 spaced apart from the anode 102. A bipolar plate 106 is interposed between the anode 102 and the cathode 104 to enable an electrical connection therebetween. In one embodiment of the invention, as best shown in FIG. 5, anode 102, bipolar plate 106 and cathode 104 are joined together to create an electrode insert 108. Electrochemical cell structure 100 (FIG. 4) further comprises an electrode frame 110. Electrode frame 110 comprises an electrolyte inlet 112, a first electrolyte flow path 114 on a top surface 116, a second electrolyte flow path 117 on a bottom surface 118 (shown with dotted lines), a seat 120, an oxygen flow path 122 on top surface 116 and a hydrogen flow path 124 on bottom surface 118 (shown with dotted lines). Electrode insert 108 is positioned on seat 120. Electrochemical cell structure 100 further comprises a top diaphragm 126, a top diaphragm frame 128, a bottom diaphragm 130 and a bottom diaphragm frame 132. For purposes of discussion, in this embodiment, the top diaphragm frame 128, the top diaphragm 126, the electrode insert 108, the electrode frame 108, the bottom diaphragm 130 and the bottom diaphragm frame 132 form a repeat plate 134. An implementation of an alkaline electrolysis stack would include many, for example between about 10 to about 100, individual repeat plates 134. As shown in FIG. 6, each stack is typically capped with an end cap 140, an anode 102 and a current collector 142 at one end and an end cap 140, a cathode 104 and a current collector 142 at an opposite end.

In operation, an electrolyte is introduced via inlet 112 (FIG. 4) and is distributed to the anode 102 by first flow path 114 and to the cathode 104 by second flow path 117. In addition, the electrolyte flows through the top membrane 126 and the bottom membrane 130 and creates an ionic bridge between adjacent repeat plates 134. A DC current is applied to the electrode inserts 108 and a portion of the electrolyte dissociates into oxygen and hydrogen at each anode 102 and cathode 104, respectively, within a representative stack. The oxygen and a portion of the electrolyte flow through oxygen flow path 122 to an oxygen outlet 123 and the hydrogen and a portion of the electrolyte flow through hydrogen flow path 124 to a hydrogen outlet 125. Additional flow paths (not shown) are provided between adjacent repeat plates 134 to allow the electrolyte to flow to one of the inlet 112, the oxygen outlet 123 and the hydrogen outlet 125.

As shown best in FIG. 4, the top diaphragm support 128, the electrode frame 110 and the bottom diaphragm support 132 components, of each repeat plate 134 are made of a nonconductive materials, and typically, although not necessarily, have the same general geometry. For purposes of clarity, these combined components are referred to as nonconductive frame 150. In one embodiment, nonconductive frame 150 comprises a material having a maximum working temperature in a range between about 60 degrees Celsius to about 120 degrees Celsius. This temperature range would support most alkaline electrolysis applications. In another embodiment, nonconductive frame 150 comprises a material having a maximum working temperature in a range between about 60 degrees Celsius to about 300 degrees Celsius. This temperature range would support most alkaline electrolysis and fuel cell applications as well as most proton exchange membrane (PEM), polybenzimidazole (PBI), and acid electrolysis and fuel cell applications.

In one embodiment of the instant invention, the nonconductive frame 150 comprises a polymer, typically a polymer chemically resistant to caustic to avoid degradation during prolonged exposure to bases like KOH or NaOH. In another embodiment, the nonconductive frame 150 comprises a hydrolytically stable polymer. In another embodiment, the nonconductive frame 150 is selected from the group consisting of polyethylene, fluorinated polymers, polypropylene, and polysulfone polyphenyleneoxide, polyphenylenesulfide, polystyrene and blends thereof.

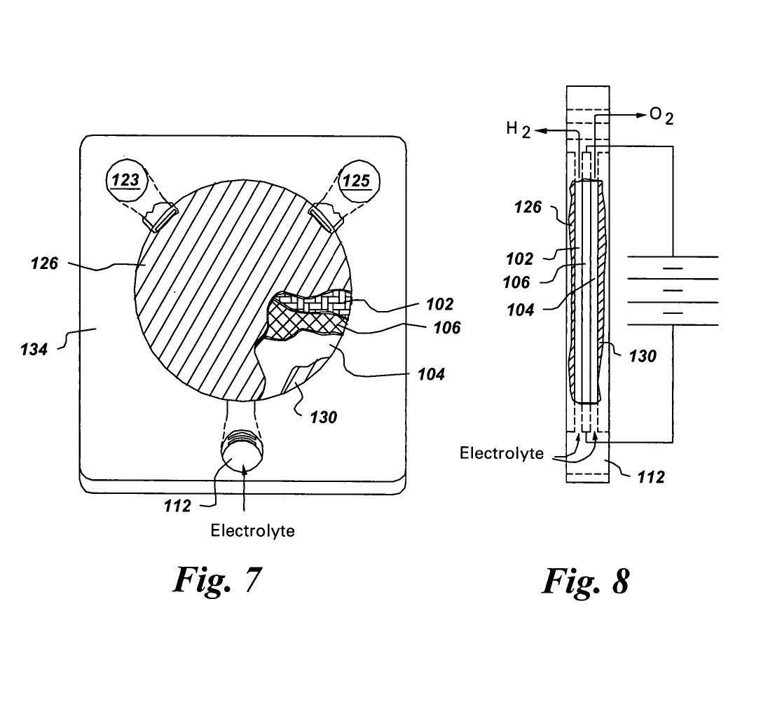

In reference to FIGS. 7 and 8, repeat plate 134 is depicted as a single unit. Each repeat plate 134 is constructed to provide an inlet 112 for the electrolyte. As best shown in FIG. 8, the electrolyte splits into two streams on either side of the bipolar plate 106 and dissociates into H₂ and O₂. The diaphragms 126 and 130 bound each side of the electrode insert to ensure the H₂ and O₂ do not mix between adjacent repeat plates 134. The construction of this exemplary repeat plate 134 is simple and avoids the use of seals or gaskets. As depicted, the electrode insert 108 and the diaphragms 126 and 130 are supported and encased within the single-piece nonconductive frame of repeat plate 134. The flow paths for the electrolyte are also defined by the single-piece nonconductive frame of repeat plate 134, essentially removing any need for gasketing within the system.

In one embodiment of the invention, the electrochemical cell structure is fabricated according to the process discussed in reference to FIG. 9. First an electrode assembly is positioned within a first nonconductive frame piece S1. As discussed above, the electrode assembly typically comprises an anode, a cathode and a bipolar plate. Next, a second nonconductive frame piece is applied to the first nonconductive frame piece to sandwich the electrode assembly therebetween S2. Next, the first and second nonconductive frame pieces are joined together to form a single-piece nonconductive frame unit about the electrode assembly S3. Additional nonconductive frame pieces and additional component parts may be added as per requirements, for example, a diaphragm frame and a diaphragm. Multiple single-piece nonconductive frame units are joined together to form an electrochemical stack structure having a single-piece nonconductive frame. In one embodiment, the frame pieces or units are joined together by adhesive. In another embodiment, the frame pieces or units are joined together using ultrasonic or laser welding. In yet another embodiment, the frame pieces or units are joined together by applying heat or current to melt the pieces or units together.

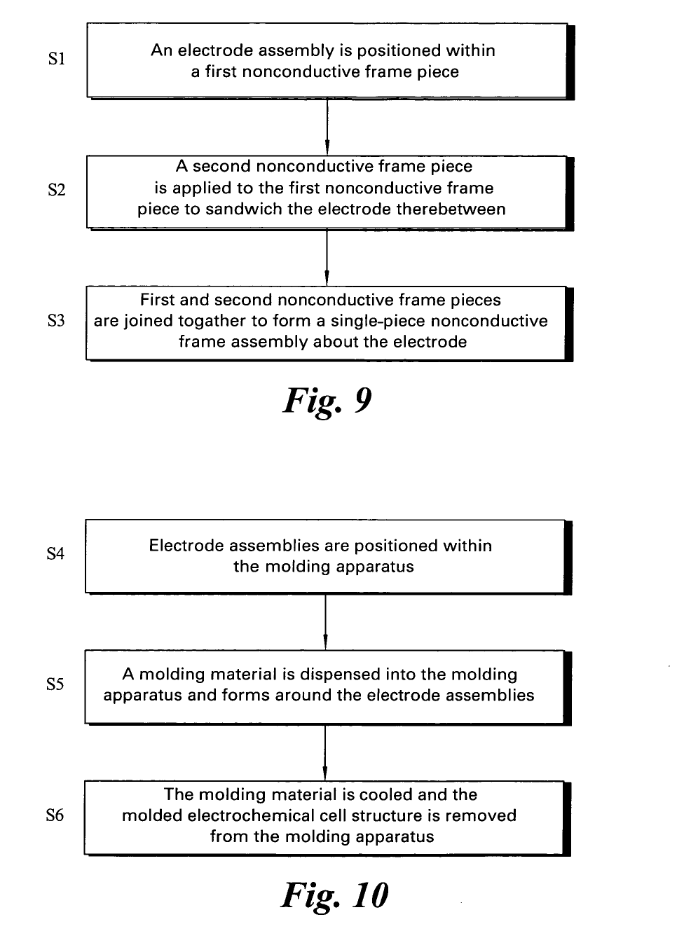

In another embodiment, the electrochemical cell structure is fabricated according to the process discussed in reference to FIG. 10. First at least one and typically a plurality of electrode assemblies are positioned within a molding apparatus S4. As discussed above, the electrode assembly typically comprises an anode, a cathode and a bipolar plate. Next, a heated molding material, typically a polymer, is dispensed into the molding apparatus and flows around the provided electrode assemblies S5. Finally, the molding material is cooled and the electrochemical cell structure is removed from the molding apparatus S6. In this embodiment, the single-piece nonconductive frame is formed in place around the electrode assemblies, thereby further simplifying the fabrication process. The flow channels and pathways are predefined in the molding apparatus to ensure proper flow of working fluids and ionic byproducts during use. Additional component parts can be included if required, for example, diaphragms may be positioned within the molding apparatus prior to S5.

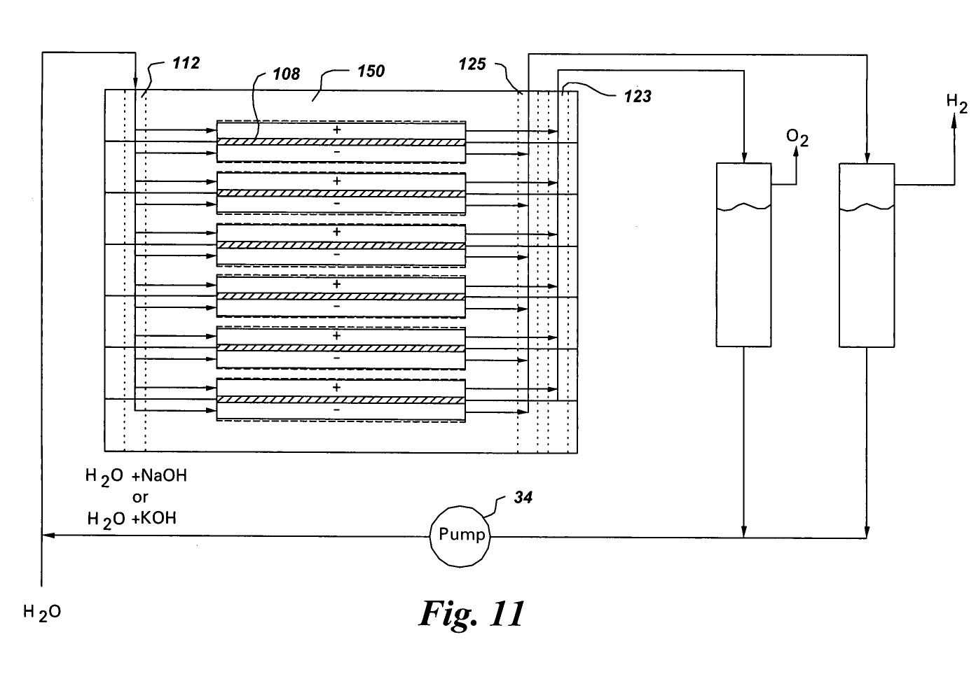

One embodiment of the instant invention is depicted in FIG. 11. Water (H₂O) is supplied into the system and is circulated by pump 34. The water is combined with an alkaline base, typically Potassium Hydroxide (KOH) or Sodium Hydroxide (NaOH), to form a liquid alkaline electrolyte that is circulated by pump 34 to the inlet 112 formed in the single-piece nonconductive frame 150. A plurality of electrode inserts 108 is positioned within the single-piece nonconductive frame and is separated from adjacent electrode inserts 108 by diaphragms, as discussed above. The electrolyte flows though the inlet 112 and to each of the respective electrode inserts 108. Direct current voltage is applied to the electrode inserts 108 in the presence of the electrolyte. The direct current voltage splits the water into its constituents of hydrogen (H₂) at the cathode and oxygen (O₂) at the anode. The diaphragms keep the H₂ and O₂ gases separated. The O₂ gas in mixture with electrolyte is transported via oxygen outlet 123 (defined by single-piece nonconductive frame 150) to an oxygen separator. After separation from the electrolyte, the O₂ gas is stored, vented, or otherwise utilized and a portion of the electrolyte is recirculated by pump 34 into the system. The H₂ gas in mixture with liquid electrolyte is transported via hydrogen outlet 125 (defined by single-piece nonconductive frame 150) to a hydrogen separator. After separation from the electrolyte, the H₂ gas is captured and stored, burned, electrochemically reacted or otherwise utilized and a portion of the electrolyte is recirculated by pump 34 into the system.

While only certain features of the invention have been illustrated and described herein, many modifications and changes will occur to those skilled in the art. It is, therefore, to be understood that the appended claims are intended to cover all such modifications and changes as fall within the true spirit of the invention.

1. An electrochemical cell structure comprising:
an anode;
a cathode spaced apart from said anode;
an electrolyte in ionic communication with each of said anode and said cathode; and
a single-piece nonconductive frame that supports each of said anode, said cathode and said electrolyte and defines at least one flowpath for working fluids and for byproducts of ionic exchange.

2. An electrochemical cell structure in accordance with claim 1, wherein said single-piece nonconductive frame comprises a material having a maximum working temperature in a range between about 60 degrees Celsius to about 120 degrees Celsius.

3. An electrochemical cell structure in accordance with claim 1, wherein said single-piece nonconductive frame comprises a material having a maximum working temperature in a range between about 60 degrees Celsius to about 300 degrees Celsius.

4. An electrochemical cell structure in accordance with claim 1, wherein said electrochemical cell structure is suitable as an alkaline electrolyzer.

5. An electrochemical cell structure in accordance with claim 4, wherein said electrolyte is a liquid alkaline solution.

6. An electrochemical cell structure in accordance with claim 5, wherein said electrolyte is selected from the group consisting of Sodium Hydroxide or Potassium Hydroxide.

7. An electrochemical cell structure in accordance with claim 1, wherein said single-piece nonconductive frame comprises a formed compononent.

8. An electrochemical cell structure in accordance with claim 7, wherein said formed component comprises a molded component.

9. An electrochemical cell structure in accordance with claim 1, wherein said single-piece nonconductive frame comprises a plurality of individual component parts joined together.

10. An electrochemical cell structure in accordance with claim 9, wherein said component parts are joined together using an adhesive.

11. An electrochemical cell structure in accordance with claim 9, wherein said component parts are joined together with at least one of ultrasonic or laser welding.

12. An electrochemical cell structure in accordance with claim 9, wherein said component parts are joined together by melting and cooling.

13. An electrochemical cell structure in accordance with claim 1, wherein said nonconductive frame material comprises a polymer.

14. An electrochemical cell structure in accordance with claim 1, wherein said nonconductive frame comprises a material that is chemically resistant to caustic.

15. An electrochemical cell structure in accordance with claim 1, wherein said nonconductive frame material comprises a hydrolytically stable polymer.

16. An electrochemical cell structure in accordance with claim 1, wherein said nonconductive frame material is selected from the group consisting of polyethylene, fluorinated polymers, polypropylene, polysulfones polyphenyleneoxide, polyphenylenesulfide, polystyrene and combinations thereof.

17. A cell structure for an alkaline electrolyzer comprising:
an anode;
a cathode spaced apart from said anode;
a liquid alkaline electrolyte in ionic communication with each of said anode and said cathode; and
a single-piece nonconductive polymer frame that supports each of said anode, said cathode and said electrolyte and defines at least one flowpath for working fluids and for byproducts of ionic exchange.

18. A cell structure for an alkaline electrolyzer in accordance with claim 17, wherein said single-piece nonconductive polymer frame comprises a material that is chemically resistant to caustic.

19. A cell structure for an alkaline electrolyzer in accordance with claim 17, wherein said single-piece nonconductive polymer frame comprises a hydrolytically stable polymer.

20. A cell structure for an alkaline electrolyzer in accordance with claim 17, wherein said single-piece nonconductive polymer frame comprises a material selected from the group consisting of polyethylene, fluorinated polymers, polypropylene, polysulfones polyphenyleneoxide, polyphenylenesulfide, polystyrene and combinations thereof.

21. An electrochemical stack comprising:
a first end cap having a noncoductive housing and an anode disposed therein;
a second end cap having a noncoductive housing and a cathode disposed therein; and
a plurality of repeat plates interposed between said first and said second end caps, each of said repeat plates comprising a nonconductive housing and an electrode insert disposed therein;
wherein each of said nonconductive housings of said first end plate, said repeat plates, and said second end plate are joined together to form a single-piece nonconductive frame and define a plurality of flow paths within said electrochemical stack.

22. An electrochemical stack in accordance with claim 21, wherein said nonconductive frame comprises a polymer material.

23. An electrochemical stack in accordance with claim 21, wherein said nonconductive frame comprises a material that is chemically resistant to caustic.

24. An electrochemical stack in accordance with claim 21, wherein said nonconductive frame comprises a hydrolytically stable polymer.

25. An electrochemical stack in accordance with claim 21, wherein said nonconductive frame comprises a material selected from the group consisting of polyethylene, fluorinated polymers, polypropylene, and polysulfones.

26. An electrochemical stack in accordance with claim 21, wherein said electrode insert comprises an anode and a cathode and a bipolar plate interposed therebetween.

27. An electrochemical stack in accordance with claim 21, wherein said repeat plate further comprises a first diaphragm and a second diaphragm disposed on opposite sides of said electrode insert to promote separation of gases.

28. A repeat plate for fabrication of a electrochemical stack, said repeat plate comprising:
a single-piece nonconductive frame defining a plurality of flow paths and an electrode frame; and
an electrode assembly disposed within said electrode frame.

29. A repeat plat in accordance with claim 28, wherein said a single-piece nonconductive frame comprises a polymer material.

30. A repeat plate for fabrication of an alkaline electrolysis stack, said repeat plate comprising:
an anode, a cathode and a bipolar plate interposed therebetween, joined together to define an electrode assembly; a single-piece nonconductive frame defining an electrolyte inlet, at least a first flow path in fluid communication with said anode and a second electrolyte flow path in fluid communication with said cathode, an electrode frame that supports said electrode assembly, an oxygen flow path in fluid communication with said anode and terminating in an oxygen outlet and a hydrogen flow path in fluid communication with said cathode and terminating in a hydrogen outlet; a first diaphragm disposed adjacent said anode opposite said bipolar plate to promote electrolyte flow between adjacent repeat plates but to prevent the oxygen from mixing with hydrogen formed at an adjacent repeat plate cathode; a second diaphragm disposed adjacent said cathode opposite said bipolar plate to promote electrolyte flow between adjacent repeat plates but to prevent the hydrogen from mixing with the oxygen formed at an adjacent repeat plate anode; wherein upon introduction of an electrolyte and application of an electric current between adjacent repeat plates, said electrolyte flows into said repeat plate through said electrolyte inlet and to said anode and said cathode through said first and said second electrolyte flow paths respectively, wherein a portion of said electrolyte disassociates into oxygen and hydrogen at said anode and said cathode and flows through said oxygen flow path and said hydrogen flow path respectively.

31. A repeat plate in accordance with claim 30, wherein said single-piece nonconductive frame comprises a polymer.

32. A repeat plate in accordance with claim 30, wherein said single-piece nonconductive frame comprises a hydrolytically stable polymer.

33. A repeat plate in accordance with claim 30, wherein said single-piece nonconductive frame comprises a material that is chemically resistant to caustic.

34. A repeat plate in accordance with claim 30, wherein said single-piece nonconductive frame comprises a material selected from the group consisting of polyethylene, fluorinated polymers, polypropylene, polysulfones polyphenyleneoxide, polyphenylenesulfide, polystyrene and combinations thereof.

35. An electrochemical stack comprising:
a first end cap having a noncoductive housing and an anode disposed therein;
a second end cap having a noncoductive housing and a cathode disposed therein; and
a plurality of repeat plates interposed between said first and said second end caps, each of said repeat plates comprising a nonconductive housing and an electrode insert disposed therein;
wherein each of said nonconductive housings of said first end plate, said repeat plates, and said second end plate are formed together as a single-piece nonconductive frame and define a plurality of flow paths within said electrochemical stack.

36. An electrochemical stack in accordance with claim 35, wherein said nonconductive housings are formed together using a mold.

37. A method of of electrochemical cell fabrication comprising the steps of:
positioning an electrode assembly within a first nonconductive frame piece; and
joining a second nonconductive frame piece to said first nonconductive frame piece to sandwich the electrode assembly therebetween.

38. A method in accordance with claim 37, wherein said method further comprises
positioning a diaphragm on a first side of said electrode assembly; and
joining a nonconductive frame piece to said first nonconductive frame piece to sandwich the diaphragm therebetween.

39. A method in accordance with claim 38, wherein said method further comprises
positioning a second diaphragm on a second side of said electrode assembly; and
joining a nonconductive frame piece to said second nonconductive frame piece to sandwich the second diaphragm therebetween.

40. A method of electrochemical cell fabrication comprising the steps of:
positioning a plurality of electrode assemblies within a molding apparatus;
enveloping flow channels to and from said electrode assemblies within said molding apparatus;
dispensing a heated nonconductive molding material within said molding apparatus to surround said plurality of electrode assemblies and said enveloped flow channels; and
cooling said heated nonconductive molding material to mechanically bind the electrode assemblies and define the flow channels within a single-piece nonconductive frame.

41. An electrochemical cell structure comprising:
a first electrode assembly;
a second electrode aseembly spaced apart from said first electrode assembly; and
a single-piece nonconductive frame that supports each of said first electrode assembly and said second electrode assembly and defines at least one flowpath for working fluids and for byproducts of ionic exchange.

42. An electrochemical cell structure in accordance with claim 41, wherein said nonconductive frame material comprises a polymer.
